(19) United States
(12) Patent Application Publication
(10) Pub. No.: US 2008/0227452 A1
(43) Pub. Date: Sep. 18, 2008

(54) OPTIMIZED NETWORK RE-ENTRY IN A WIRELESS COMMUNICATIONS NETWORK

(75) Inventor: Shahab M. Sayeedi, Naperville, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/041,022

(22) Filed: Mar. 3, 2008

Related U.S. Application Data
(60) Provisional application No. 60/895,228, filed on Mar. 16, 2007.

(51) Int. Cl. H04Q 7/20

(52) U.S. Cl. 455/436

(57) ABSTRACT

A method for supporting entry of a remote unit (110) onto an access service network (ASN) (120, 122). A message (180, 182) can be received from the remote unit that includes an authenticator identifier. Contextual information associated with the remote unit can be requested from an authenticator ASN (126) corresponding to the authenticator identifier. In another arrangement, the message received from the remote unit can include a data path identifier. Establishment of a bearer path connection for the remote unit can be requested from a foreign agent (162) corresponding to the data path identifier.

### REFERENCE(S) TO RELATED APPLICATION(S)

The present application claims priority from a provisional application Ser. No. 60/895,228, entitled “OPTIMIZED NETWORK RE-ENTRY IN A WIRELESS COMMUNICATIONS NETWORK,” filed Mar. 16, 2007, which is commonly owned and incorporated herein by reference in its entirety.

### BACKGROUND OF THE INVENTION

1. Field of the Invention

The present invention relates generally to communication systems and, more particularly, to supporting network re-entry from idle mode and handover in communication networks.

2. Background of the Invention

Idle mode allows a mobile station to become periodically available for downlink broadcast traffic messaging without registering at any specific base station. Indeed, the mobile station can remain in idle mode while it traverses a large geographic area populated by multiple base stations. Idle mode restricts mobile station activity to scanning at specific intervals and relieves requirements for the mobile station to perform handovers and other air interface tasks, thereby conserving mobile station power and other operational resources. Idle mode also benefits the network by providing a simple and timely method for alerting the mobile station to pending downlink traffic directed toward the mobile station, and by eliminating air interface and network handover traffic for inactive mobile stations.

When a mobile station initiates network re-entry from idle mode or idle mode exit at a new target base station which has no previous context for the mobile station, a number of sequential request messages, followed by a number of sequential response messages, are required to complete the re-entry. For example, in an IEEE 802.16e based system (e.g. WiMAX), the mobile station may send a first message, such as a range request (RNG-REQ) message, to a base station controlled by a target access service network (ASN) in order to initiate idle mode exit. Before the target ASN can respond to the first message, however, it must send a second mobile station state change request, along with a paging controller update, to an anchor paging controller/location register (PC/LR) function that is associated with the mobile station. Before the anchor PC/LR can respond to the state change request, it then must send a third message in the form of a context request to an anchor authenticator function that is associated with the mobile station in order to retrieve authenticator context associated with the mobile station.

After the PC/LR receives a response to the context request, it then can generate its own response to the state change request, which may include the authenticator context that authenticates the mobile station and an identifier for an anchor date path function. Once the mobile station is authenticated, the target ASN may then send a message to the anchor date path function associated with a foreign agent for the mobile station. This message can request that a data path bearer connection be established between the foreign agent and the base station controlled by the target ASN.

In some circumstances, for instance when network resources are heavily loaded, such serial communication exchanges can take significant periods of time to complete, resulting in an unacceptable user experience. Moreover, the length of time required for the mobile station to complete idle mode exit diminishes the energy saving benefits of the idle mode feature. In consequence, the idle mode feature is less likely to be used, which can lead to increased traffic in a communications network.

Mobile stations also may handover from one base station to another. When handover is desired, the mobile station can relay its intent to perform a handover by notifying its current serving ASN. The serving ASN, in turn, can notify the target base station(s), or target ASN(s) that control the potential target base stations, to which the mobile station may attempt to handover. The target base stations then may allow non-contention-based initial ranging opportunities and dedicated bandwidth allocations for the mobile station to support handover ranging.

For various reasons (e.g. rapidly changing air interface conditions, a mobile station entering an elevator or tunnel, poorly engineered networks, etc.) a target base station may not receive prior notification of an impending handover of a mobile station from the mobile station's current serving ASN. When such a handover occurs, it is treated as an unsolicited handover. When the target base station is controlled by an ASN that is different than the mobile station's current ASN, the unsolicited handover is known as an unsolicited inter-ASN handover.

The mobile station may initiate an unsolicited handover by anonymously sending a RNG-REQ message to a target base station in order to initiate handover ranging using a CDMA ranging code. When the mobile station ranges in this manner, it may not receive enough bandwidth from the target base station to complete handover ranging in a timely manner, if at all. Moreover, in order to complete the handover, the target ASN must receive identifiers for the anchor data path function ASN and anchor authenticator ASN, and latest media access control (MAC) context associated with the mobile station. However, since the target ASN has no context for the mobile station, before the target ASN can know from which anchor authenticator ASN it can retrieve authenticator context for the mobile station and with which anchor data path ASN it must initiate data path registration, the target ASN must first request context for the mobile station from the prior serving base station/ASN that was previously associated with the mobile station. Thus, a long series of messages must be communicated among network resources before an unsolicited handover can be completed, thereby resulting in greater latency delays in comparison to a controlled handover in which the serving base station/ASN is notified of the impending handover by the mobile station and is able to notify the target base station(s)/ASN(s) of a potential impending handover. These latency delays can be compounded by signaling delays in the network, and in some circumstances can take several seconds to complete, thereby resulting in poor handover performance and, in some cases, failure of real-time applications supported by the mobile station prior to the handover.

### SUMMARY OF THE INVENTION

The present invention relates to a method for supporting entry of a remote unit onto an access service network (ASN). The entry can be, for example, re-entry from idle mode or a handover from another base station. The method can include receiving a message from the remote unit that includes an authenticator identifier, and requesting contextual information associated with the remote unit from an authenticator function corresponding to the authenticator identifier.

In another arrangement, the method can include receiving a message from the remote unit that includes a data path identifier and requesting establishment of a bearer path connection for the remote unit from a foreign agent corresponding to the data path identifier.

The present invention also relates to a method for supporting entry of a remote unit onto an ASN. The method can include, from the remote unit, sending a request to establish network presence at the ASN. The request can include an authenticator identifier. The method also can include, at the remote unit, receiving a response to the request from the ASN.

In another arrangement, the method can include, from the remote unit, sending a request to establish network presence at an ASN. The request can include a data path identifier. The method also can include, at the remote unit, receiving a response to the request from the ASN.

### BRIEF DESCRIPTION OF THE DRAWINGS

Embodiments of the present invention will be described below in more detail, with reference to the accompanying drawings, in which:

FIG. 1 depicts a communications system that is useful for understanding the present invention;

FIG. 2 depicts a signaling flow diagram that is useful for understanding the present invention; and

FIG. 3 depicts another signaling flow diagram that is useful for understanding the present invention.

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The present invention relates to a method and a system for supporting entry of a remote unit onto an access service network (ASN). For example, the method and system can support idle mode network re-entry of the remote unit and/or an unsolicited handover of the remote unit. Notably, in comparison to the prior art, the present invention reduces the time required for idle mode re-entries and for completion of unsolicited handovers, thereby improving the user experience. In the case of unsolicited handovers, the present invention also will reduce the failure of real-time applications instantiated on remote units.

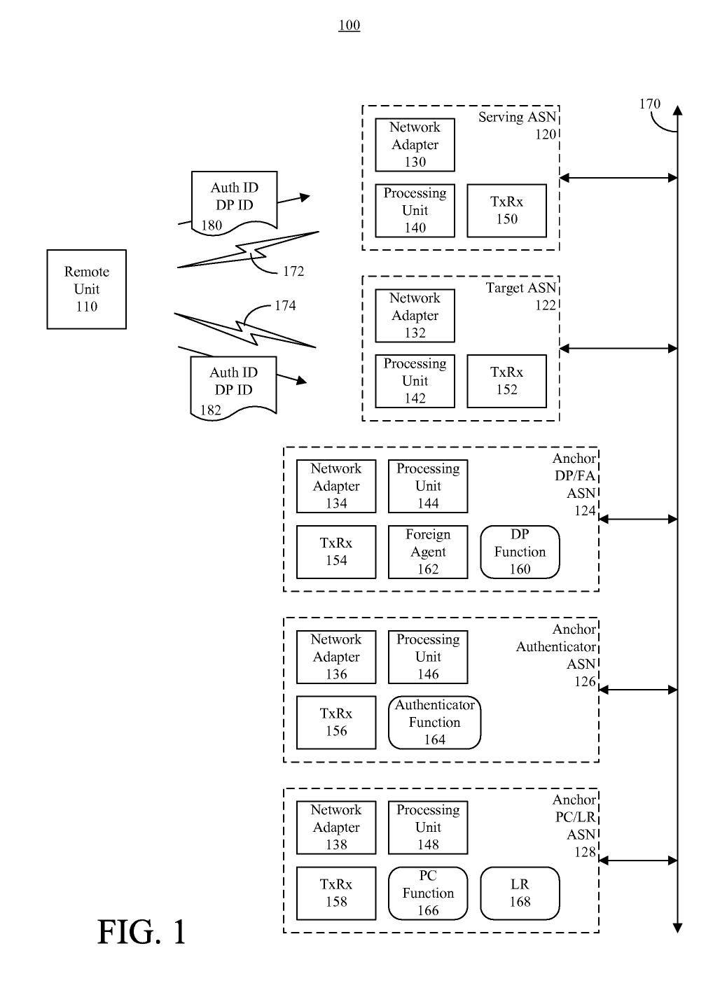

FIG. 1 depicts a communications system 100 that is useful for understanding the present invention. The communications system 100 can be implemented in accordance with one or more applicable wireless communications and air interface standards. Examples of such standards include, but are not limited to, Institute of Electrical and Electronics Engineers (IEEE) 802 wireless communications, for example, 802.11 and 802.16, standards proposed by the Open Mobile Alliance (OMA), the 3rd Generation Partnership Project (3GPP), and/or the 3rd Generation Partnership Project 2 (3GPP2). The communications system 100 also can implement any of a variety of communication protocols including, but not limited to, GSM, TDMA, CDMA, WCDMA, OFDM, etc. Modifications or deviations from the standards and/or protocols can be made to suitably implement the present invention.

The communications system 100 can include at least one remote unit 110. The remote unit 110 can be, for instance, a mobile station (e.g. a mobile telephone, a mobile radio, a mobile computer, a personal digital assistant, or the like), a computer, a wireless gaming device, an access terminal, a subscriber station, user equipment, or any other device suitably configured to communicate via a wireless communications network. As such, the remote unit 110 can comprise one or more processors/controllers, transceivers, and/or other suitable components.

The communications system 100 also can include one or more ASNs 120, 122, 124, 126, 128. The ASNs 120-128 may respectively comprise network adapters 130, 132, 134, 136, 138 and processing units 140, 142, 144, 146, 148. The network adapters 130-138 can comprise ASN gateways, wireless transceivers, wired or wireless modems, and/or any other communication devices that facilitate communication among the ASNs 120-128 via one or more communications links 170. The communications links 170 can include, for example, one or more backhauls, one or more WiMAX R4 interfaces, or any other suitable communication links.

The processing units 140-148 each can comprise, for example, one or more central processing units (CPUs), one or more digital signal processors (DSPs), one or more application specific integrated circuits (ASICs), one or more programmable logic devices (PLDs), a plurality of discrete components that can cooperate to process data, and/or any other suitable processing devices. In an arrangement in which a plurality of such components are provided, the components can be coupled together to perform various processing functions as described herein.

One or more of the ASNs 120-128 can include one or more transceivers 150, 152, 154, 156, 158, respectively. In another arrangement, only certain ones of the ASNs 120-128 may include respective transceivers 150-158. For example, the ASNs 120-122 may be provided with transceivers 150-152, while the ASNs 124-128 may be provided without transceivers. Moreover, the ASNs 120-122 each can include a plurality of transceivers. Such transceivers can be geographically distributed, for instance within geographically distributed base stations.

The transceivers 150-158 can modulate and demodulate signals to convert signals from one form to another, and can transmit and/or receive such signals over one or more various wireless communication networks. In illustration, the transceivers 150-158 can be configured to communicate data via IEEE 802 wireless communications, for example, 802.11 and 802.16. In another example, the transceivers 150-158 can communicate data via GSM, TDMA, CDMA, WCDMA or OFDM, or direct wireless communication. Further, the transceivers 150-158 also can be configured to communicate over a wireless communication link using any of a myriad of communications protocols, for example, TCP/IP.

In general, components such as network adapters, processing units and transceivers are well-known. Such components are typically adapted to implement algorithms and/or protocols that have been expressed using high-level design languages or descriptions, expressed using computer instructions, expressed using signaling flow diagrams, and/or expressed using logic flow diagrams. Further, the network adapters 130-138, processing units 140-148 and transceivers 150-158 can be implemented within suitable network components, for instance within access points, repeaters, base stations, base station controllers, mobile switching centers, etc., or across multiple network components. Still, those skilled in the art will recognize that FIG. 1 does not depict all of the physical fixed network components that may be necessary for communications system 100 to operate, but only those system components and logical entities particularly relevant to the description of embodiments herein.

The remote unit 110 can communicate with the ASN 120 via a wireless interface 172 in accordance with one or more communications protocols utilized by the transceiver 150, or any other transceivers within the ASN 120. For example, the wireless interface 172 can be implemented as a WiMAX R1 interface. When the ASN 120 is supporting the remote unit's presence on the system 100, the ASN 120 can be referred to as the serving ASN.

The ASN 122 is depicted as a potential handover target for remote unit 110, and hence is referred to as a target ASN. Should the remote unit 110 select the ASN 122 as its target for a handover (e.g. a base station controlled by the ASN 122), the remote unit 110 can communicate with the ASN 122 via a wireless interface 174 in accordance with one or more communications protocols utilized by the transceiver 152, or any other transceivers within the ASN 122. In various places of this detailed description, reference is made to a remote unit selecting the ASN 122 as its handover target. However, in many embodiments a remote unit may actually select a particular component of the ASN 122 as the handover target, such as a base station. Accordingly, references to selecting the ASN 122 (or any other ASN) should be understood to include both selecting the ASN itself or selecting a component of the ASN.

The ASN 124 is depicted as an anchor data path/foreign agent (DP/FA) ASN, the ASN 126 is depicted as an anchor authenticator ASN, and the ASN 128 is depicted as an anchor paging controller/location register (PC/LR) ASN. Such ASNs 124-128 are well known to the skilled artisan.

The anchor DP/FA ASN 124 can host a data path function 160 for the remote unit 110, as well as an associated foreign agent 162 that supports mobile IP or proxy mobile IP functionality for the remote unit 110. The data path function 160 and corresponding foreign agent 162 can be in accordance with those described in the WiMAX Forum document entitled “WiMAX End-to-End Network Systems Architecture (Stage 3: Detailed Protocols and Procedures) V&V Draft.” For example, the data path function 160 can establish a bearer data path for the remote unit 110.

The anchor authenticator ASN 126 can provide an authenticator function 164, which may retain authenticator context that may be used to authenticate the remote unit 110. The anchor PC/LR ASN 128 can provide a paging controller function 166 that supports paging functionality for the remote unit 110, and a location register 168 that retains location information and idle mode state information for the remote unit 110. The location register 168 also can retain an identifier or address for the data path function 160 associated with the foreign agent 162.

Although the anchor DP/FA ASN 124 and the anchor authenticator ASN 126 are depicted as separate components in the communications system 100, in another arrangement a single ASN may host the date path function 160 (with its corresponding foreign agent 162) and the authenticator function 164, and thus may serve as both anchor DP/FA and anchor authenticator. Moreover, such functions 160-164 can be implemented by other ASNs. For example, the serving ASN 120 and/or the target ASN 122 can additionally host the date path function 160 (with its corresponding foreign agent 162) and/or the authenticator function 164 in place of the ASN 124 and/or the ASN 126.

In operation, the remote unit 110 can initiate network re-entry from idle mode by sending a message 180 to the serving ASN 120. The message 180 can include an authenticator identifier that identifies the anchor authenticator ASN 126 and a data path identifier that identifies the anchor DP/FA ASN 124. The authenticator identifier can be a logical network identifier or an address of the anchor authenticator ASN 126 (e.g. the authenticator function 164). The data path identifier can be a logical network identifier or an address of the anchor DP/FA ASN 124 (e.g. the data path function 160 and/or foreign agent 162). The message 180 also can include a paging controller identifier, for example a logical network identifier or an address that identifies the anchor PC/LR ASN 128 (e.g. the paging controller function 166 and/or the location register 168).

Similarly, the remote unit 110 can initiate an unsolicited handover to the target ASN 122 by sending a message 182 to the target ASN 122. The message 182 also can include an authenticator identifier that identifies the anchor authenticator ASN 126, a data path identifier that identifies the anchor DP/FA ASN 124, and a paging controller identifier that identifies the anchor PC/LR ASN 128.

In one arrangement, the message 180 and/or the message 182 can be sent as a range request (RNG-REQ) message sent to a respective ASN 120, 122. In such an arrangement, the authenticator identifier and data path identifier can be included in the messages 180, 182 as type-length-values (TLVs). Further, in the case of re-entry from idle mode, the message 180 can include the paging controller identifier as a TLV.

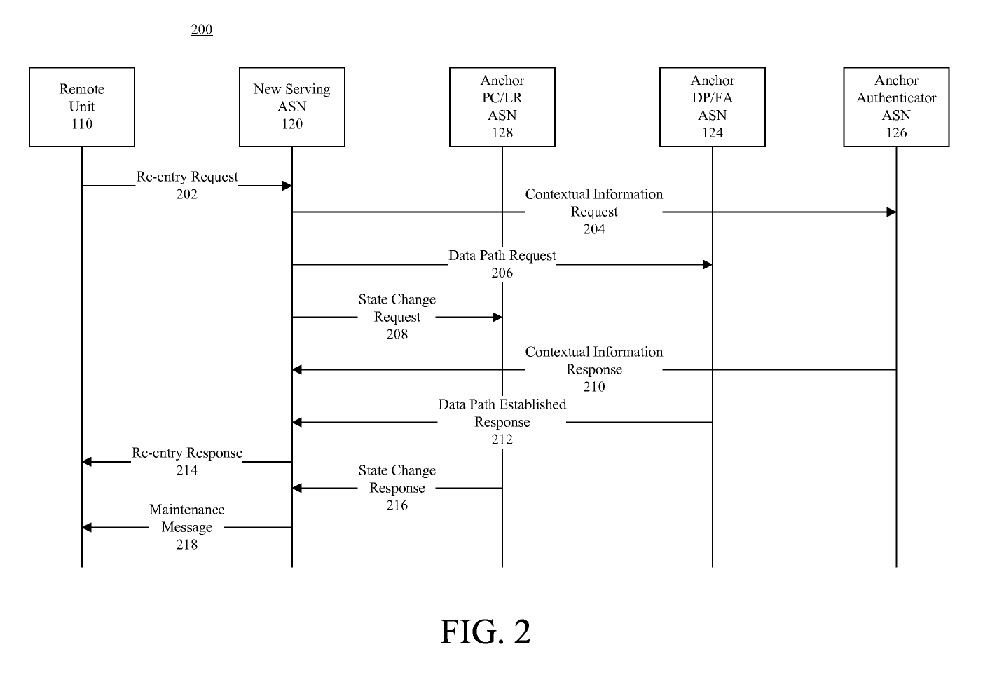

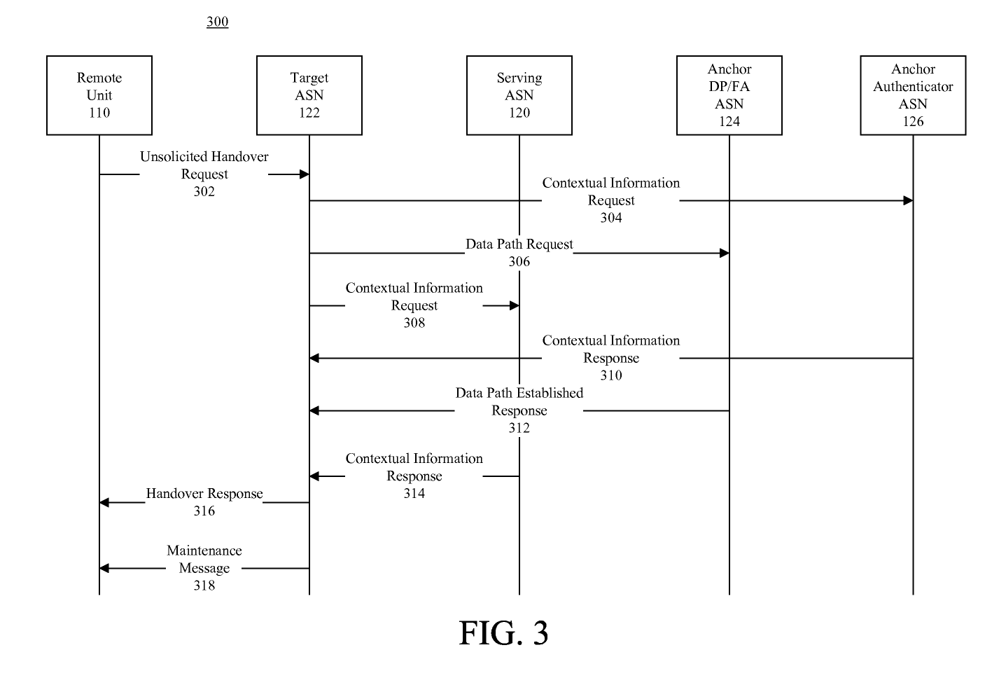

The message 180 can be processed by the serving ASN 120 to facilitate re-entry of the remote unit 110 from idle mode, as will be described with reference to FIG. 2. Further, the message 182 can be processed by the target ASN 122 to facilitate handover of the remote unit 110 from the serving ASN 120 to the target ASN 122, as will be described with reference to FIG. 3.

FIG. 2 depicts an example of a signaling flow diagram 200 that may be implemented to facilitate network re-entry of the remote unit 110 from idle mode. The signaling flow diagram can begin in a state in which the remote unit 110 is in idle mode and, while in idle mode, has moved into a geographic region supported by a new serving ASN 120. Accordingly, the new serving ASN 120 may not have contextual information, such as authentication context or an authenticator ASN identifier, for the remote unit 110.

Beginning at step 202, the remote unit 110 can initiate an idle mode network re-entry by sending a message to the new serving ASN 120 requesting network re-entry from idle mode. The message can include the authenticator identifier and/or the data path identifier in addition to the paging controller identifier, each of which can be contained in a TLV and easily parsed. The message also can include a ranging purpose indication indicating that the remote unit 110 is attempting network re-entry from idle mode. In the case in which the message requesting network re-entry from idle mode is a 802.16e-2005 RNG-REQ, the message also can include an HMAC/CMAC tuple at the end of the message for authentication purposes, which is well known to those skilled in the art.

At step 204, the new serving ASN 120 can send a message requesting contextual information for the remote unit 110. Such message can be sent to the anchor authenticator ASN 126 indicated by the authenticator identifier contained in the request received at step 202. For example, the message can be sent to an authenticator function hosted by the authenticator ASN 126.

At step 206, the new serving ASN 120 can send a message requesting, from a foreign agent, establishment of a bearer data path for the remote unit 110. This message can be sent to the anchor DP/FA ASN 124 corresponding to the data path identifier received in the request at step 202. For example, the message can be sent to a data path function hosted on the anchor DP/FA ASN 124 that is associated with the foreign agent, or the message can be sent to the foreign agent itself. The message can be sent prior to the new serving ASN 120 receiving contextual information from the anchor authenticator ASN 126, or after the new serving ASN 120 has received the contextual information for the remote unit 110 requesting handover.

At step 208, the new serving ASN 120 can send a message requesting a paging controller and location register update for the remote unit 110. This message can be sent to the anchor PC/LR ASN 128 indicated by the paging controller identifier received in step 202. For example, the message can be sent to a paging controller function hosted on the PC/LR ASN 128. The state change request message can notify the paging controller that the remote unit is exiting idle mode, as well as indicate the current location through which the remote unit 110 is attempting network re-entry. In response to the state change request message, the anchor PC/LR ASN can change the state of the remote unit 110 from idle to active and update the remote unit's location in the location register.

Notably, the preceding steps 204-208 can be implemented as soon as the new serving ASN 120 has received the re-entry request message from the remote unit 110. Moreover, because the re-entry request identifies the ASNs 124-128 to which the various messages are to be sent, in contrast to the prior art, the steps 204-208 can be implemented contemporaneously or substantially contemporaneously (e.g. within nanoseconds, microseconds or milliseconds of each other).

At step 210, the anchor authenticator ASN 126 (e.g. the authenticator function hosted on the authenticator ASN 126) can respond to the contextual information request (communicated in step 204) by sending to the new serving ASN 120 a contextual information response message containing the authentication context for the remote unit 110. The authentication context can include, for instance, an authentication key. The contextual information response may be processed by the new serving ASN 120 to authenticate the remote unit 110. Receipt of the contextual information response message may occur any time after step 204.

At step 212, the anchor DP/FA ASN 124 (e.g. the data path function associated with the foreign agent at the anchor DP/FA ASN 124 or the foreign agent itself) can respond to the bearer data path establishment request (communicated in step 206) by sending a message to the new serving ASN 120 indicating that the data path has been established for the remote unit 110. This message may arrive any time after step 206.

At step 214, the new serving ASN 120 can respond to the idle mode re-entry request by sending a message to the remote unit 110 indicating the network is ready for re-entry of the remote unit 110 from idle mode. For example, in the case of an 802.16e based network such as WiMAX, if the new serving ASN 120 has successfully authenticated the HMAC/CMAC tuple received in a RNG-REQ message in step 202, the new serving ASN 120 can send to the remote unit 110 a range response (RNG-RSP) message containing a corresponding HMAC/CMAC tuple. Notably, the RNG-RSP message can be sent any time after step 210. Indeed, the RNG-RSP message can be sent before or after step 212. If the RNG-RSP message is sent before step 212, the remote unit 110 may experience expedited network re-entry, although if the remote unit 110 begins sending data to the new serving ASN 120, the new serving ASN 120 may buffer the data until a message is received from the Anchor DP/FA ASN 124 confirming establishment of the data path for the remote unit 110.

At step 216, the anchor PC/LR ASN 128 can respond to the state change request sent in step 208 with a message confirming that the state of the remote unit 110 has been changed and that the remote unit's location has been updated in the location register.

At step 218, the new serving ASN 120 can send a maintenance message to the remote unit 110. The maintenance message can include a new data path identifier and/or authenticator identifier. Such identifiers can be communicated to the remote unit in respective TLVs any time the data path or the anchor authenticator 126 change. One example of such a message that may be used in WiMAX is a Re/De-Register command (DREG-CMD) message. This updated information can be included in future idle mode re-entry requests or handover requests sent by the remote unit 110.

The messages depicted in the signaling flow diagram as being communicated between ASNs 120-130 (e.g. in steps 204-212 and step 216) can be communicated via a backbone communication link or, in the case of WiMAX, over an R4 or R6 interface. The messages communicated between the remote unit 110 and the new serving ASN 120 can be communicated in accordance with a communications protocol implemented by the new serving ASN 120, as previously noted.

FIG. 3 depicts an example of a signaling flow diagram that may be implemented to facilitate unsolicited handover of the remote unit 110 from the serving ASN 120 to the target ASN 122. At step 302, the remote unit 110 can send a message to the target ASN 122 to request an unsolicited handover. For example, the remote unit 110 can send a RNG-REQ message to the target ASN 122. The message can include the authenticator identifier, the data path identifier and a serving base station identifier, each of which can be contained in a TLV and easily parsed from the message. In the case in which the message requesting network re-entry is a WiMAX RNG-REQ, the message also can include an HMAC/CMAC tuple.

If the target ASN 122 has no contextual information for the remote unit 110, at step 304 the target ASN 122 can send a message requesting the contextual information. This message can be sent to the anchor authenticator ASN 126 identified by the authenticator identifier received from the remote unit 110. For example, the message can be sent to an authenticator function hosted by the authenticator ASN 126.

At step 306, the target ASN 122 can send a message to the anchor DP/FA ASN 124 requesting, from a foreign agent, establishment of a bearer data path for the remote unit 110. The anchor DP/FA ASN 124 can correspond to the data path identifier received from the remote unit 110. For example, the message can be sent to a data path function hosted on the anchor DP/FA ASN 124 that is associated with the foreign agent, or the message can be sent to the foreign agent itself. The message can be sent prior to receiving contextual information from the anchor authenticator ASN 126, or after receiving contextual information for the remote unit 110 requesting handover.

At step 308, the target ASN 122 can send a message requesting contextual information from the ASN 120 previously serving the remote unit 110. For example, the target ASN 122 can request latest media access control (MAC) context from the previous serving ASN 120. In one arrangement, the message can be sent to a previous serving ASN that corresponds to the serving base station identifier received from the remote unit 110.

At step 310, the anchor authenticator ASN 126 (e.g. the authenticator function hosted on the authenticator ASN 126) can respond to the contextual information request (communicated in step 304) by sending to the target ASN 122 a contextual information response message containing the authentication context for the remote unit 110. The authentication context can include, for instance, an authentication key. The contextual information response may be processed by the target ASN 122 to authenticate the remote unit 110. Receipt of the contextual information response message may occur any time after step 304.

At step 312, the anchor DP/FA ASN 124 (e.g. the data path function associated with the foreign agent at the anchor DP/FA ASN 124 or the foreign agent itself) can respond to the data path request by sending a message to the target ASN 122 indicating that the data path has been established for the remote unit 110. This message may arrive any time after step 306.

At step 314, the previously serving ASN 120 can respond to the contextual information request (communicated in step 308) by sending to the target ASN 122 a message containing contextual information for the remote unit 110. For instance, such message can contain the latest MAC context for the remote unit 110.

At step 316, the target ASN 122 can respond to the handover request by sending a message to the remote unit 110 indicating the network is ready for handover of the remote unit 110 to the target ASN 122. For example, in the case of an 802.16e based network such as WiMAX, if the target ASN 122 has successfully authenticated the HMAC/CMAC tuple received in a RNG-REQ message in step 302, the target ASN 122 can send to the remote unit 110 a RNG-RSP message containing a corresponding HMAC/CMAC tuple.

At step 318, the target ASN 122 can send a maintenance message to the remote unit 110. Such a message also can be sent any other time an anchor function address or identifier changes. The maintenance message can include a new data path identifier and an authenticator identifier. Such identifiers can be communicated to the remote unit in respective TLVs any time the data path or anchor authenticator 126 change. One example of such a message that may be used in WiMAX is a De/Re-register command (DREG-CMD) message. This updated information can be included in future idle mode re-entry requests or handover requests sent by the remote unit 110.

The signaling flow diagrams and the block diagram in the figures illustrate the architecture, functionality, and operation of possible implementations of systems, methods and computer program products according to various embodiments of the present invention. In this regard, each step of the signaling flow diagrams or block in the block diagrams may represent a module, segment, or portion of code, which comprises one or more executable instructions for implementing the specified logical function(s). It should also be noted that, in some alternative implementations, the functions noted in the signaling flow diagrams may occur out of the order noted in the figures. For example, two steps shown in succession may, in fact, be executed substantially concurrently, or the steps may sometimes be executed in the reverse order, depending upon the functionality involved.

The present invention can be realized in hardware, software, or a combination of hardware and software. The present invention can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with an application that, when being loaded and executed, controls the processing system such that it carries out the methods described herein. The present invention also can be embedded in a program storage device readable by a machine, tangibly embodying a program of instructions executable by the machine to perform methods and processes described herein. The present invention also can be embedded in an application product which comprises all the features enabling the implementation of the methods described herein and, which when loaded in a processing system, is able to carry out these methods.

The terms “function,” “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a subroutine, a function, a procedure, an object method, an object implementation, an executable application, an applet, a servlet, a MIDlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language).

This invention can be embodied in other forms without departing from the spirit or essential attributes thereof. Accordingly, reference should be made to the following claims, rather than to the foregoing specification, as indicating the scope of the invention.

What is claimed is:

1. A method for supporting entry of a remote unit onto an access service network (ASN), comprising:
receiving a message from the remote unit that includes an authenticator identifier; and
requesting contextual information associated with the remote unit from an authenticator function corresponding to the authenticator identifier.

2. The method of claim 1, wherein receiving the message from the remote unit comprises receiving a data path identifier included in the message, the method further comprising requesting establishment of a bearer path connection for the remote unit from a function associated with a foreign agent corresponding to the data path identifier.

3. The method of claim 1, further comprising sending a message to the remote unit that includes the authenticator identifier.

4. The method of claim 1, wherein receiving the message from the remote unit comprises receiving a paging controller identifier included in the message, the method further comprising sending a mobile location update or a state change request to a paging controller corresponding to the paging controller identifier.

5. The method of claim 1, wherein receiving the message from the remote unit comprises receiving a range request message.

6. The method of claim 1, wherein receiving the message from the remote unit comprises receiving a re-entry from idle mode request message.

7. The method of claim 6, further comprising sending a re-entry from idle mode response to the remote unit.

8. The method of claim 1, wherein receiving the message from the remote unit comprises receiving a request for handover.

9. The method of claim 8, further comprising sending a response to the request for handover to the remote unit.

10. The method of claim 1, further comprising:
in response to detecting a new authenticator or a new data path associated with the remote unit, sending a maintenance message to the remote unit, the maintenance message comprising at least one identifier selected from the group consisting of a new authenticator identifier and a new data path identifier.

11. A method for supporting entry of a remote unit onto an access service network (ASN), comprising:
receiving a message from the remote unit that includes a data path identifier; and
requesting establishment of a bearer path connection for the remote unit from a foreign agent corresponding to the data path identifier.

12. The method of claim 11, further comprising sending a message to the remote unit that includes the data path identifier.

13. A method for supporting entry of a remote unit onto an access service network (ASN), comprising:
from the remote unit, sending a request to establish network presence at the ASN, the request comprising an authenticator identifier; and
at the remote unit, receiving a response to the request from the ASN.

14. The method of claim 13, wherein sending the request comprises sending a range request message.

15. The method of claim 13, wherein sending the request comprises sending an idle mode network re-entry request message.

16. The method of claim 15, further comprising receiving a re-entry response from the ASN.

17. The method of claim 13, wherein sending the request comprises sending a handover request.

18. The method of claim 17, further comprising receiving a response to the handover request from the ASN.

19. The method of claim 13, further comprising:
receiving a maintenance message in response to a new authenticator ASN or a new data path ASN being identified as being associated with the remote unit, the maintenance message comprising at least one identifier selected from the group consisting of a new authenticator identifier and a new data path identifier.

20. A method for supporting entry of a remote unit onto an access service network (ASN), comprising:
from the remote unit, sending a request to establish network presence at the ASN, the request comprising a data path identifier; and
at the remote unit, receiving a response to the request from the ASN.
